(19) United States
(12) Patent Application Publication
(10) Pub. No.: US 2015/0058785 A1
(43) Pub. Date: Feb. 26, 2015

(54) Character Input Device And Computer Readable Recording Medium

(71) Applicant: CASIO COMPUTER CO., LTD, Shibuya-ku (JP)

(72) Inventor: Hirokazu OOKAWARA, Iruma-shi (JP)

(21) Appl. No.: 14/465,461

(22) Filed: Aug. 21, 2014

(30) Foreign Application Priority Data
Aug. 21, 2013 (JP) 2013-171372

(51) Int. Cl. G06F 3/0488; G06F 3/0484

(52) U.S. Cl. CPC G06F 3/04886; G06F 3/04842
USPC 715/773

(57) ABSTRACT

A character input device, including: a touch panel which integrally includes a display unit and an input unit; a first control unit which displays a character input screen having a character display region on the display unit, associates a keyboard including a plurality of characters with the touch panel and displays a character in the keyboard corresponding to a position where a touch input is performed via the input unit in the character display region as an input target character; an evaluation unit which obtains an evaluation value for the input target character on basis of an input manner; a determination unit which determines whether the input target character is a correction target character on basis of the evaluation value; and a second control unit which displays the correction target character on the display unit so as to be distinguishable.

### FIELD OF THE INVENTION

The present invention relates to a character input device and a computer readable recording medium.

### DESCRIPTION OF RELATED ART

In recent years, an increasing number of mobile terminals such as smartphones and tablet terminals can be operated via touch panels. In such device, a software keyboard is displayed on a display screen, and a character can be input by touching or flicking a character button on the software keyboard.

Such software keyboard is displayed as an image simulating an actual JIS (Japan Industrial Standard) keyboard or a keypad used in a mobile phone.

An actual keyboard is provided with projections on the “F” key and the “J” key, which enables a user to recognize what is called a home position only by the sense of touch and facilitates touch typing. In a mobile phone, a projection is provided on the “5” key in the keypad, which facilitates tactile operations.

On the other hand, since the software keyboard is not provided with such projection, a character is input by a user touching the position of the character in the software keyboard displayed on the screen while visually recognizing the position. Accordingly, since the user cannot have the tactile sense as in the actual keyboard, there is a problem of incorrect input due to the user touching a position deviated from a desired position.

In view of such problem, a conventional character input device has a configuration that when a key input by a user is detected at the software keyboard including a plurality of keys, keys adjacent to the detected key are extracted, the detected key and the extracted keys are stored, conversion candidates are generated from the stored keys and the generated conversion candidates are displayed on the display screen (for example, Japanese Patent Application Laid Open Publication No. 2013-47872).

However, in the invention described in Japanese Patent Application Laid Open Publication No. 2013-47872, all the conversion candidates which meet the conditions are displayed on the display screen regardless of whether the key input is correct, and one of the displayed conversion candidates is to be selected. Thus, such device requires a troublesome task of finding the desired conversion candidate one by one. In addition, whether the input is wrong cannot be recognized rapidly, leading to a bad operability.

### SUMMARY OF THE INVENTION

An object of the present invention is to make incorrect input recognized rapidly.

According to one aspect of the present invention, there is provided a character input device, including: a touch panel which integrally includes a display unit for displaying a screen and an input unit for receiving a touch input at a position in the screen displayed on the display unit; a first control unit which displays a character input screen having a character display region on the display unit, associates a keyboard including a plurality of characters with the touch panel and displays a character in the keyboard corresponding to the position where the touch input is performed via the input unit in the character display region as an input target character; an evaluation unit which obtains an evaluation value for the input target character on basis of an input manner in which the touch input is performed via the input unit; a determination unit which determines whether the input target character is a correction target character on basis of the evaluation value for the input target character obtained by the evaluation unit; and a second control unit which displays the correction target character determined by the determination unit on the display unit so as to be distinguishable.

According to another aspect of the present invention, there is provided a non-transitory computer readable medium that stores a program for making a computer execute a procedure, the computer being a character input device with a touch panel which integrally includes a display unit for displaying a screen and an input unit for receiving a touch input at a position in the screen displayed on the display unit, the procedure including: controlling so as to display a character input screen having a character display region on the display unit, associate a keyboard including a plurality of characters with the touch panel and display a character in the keyboard corresponding to the position where the touch input is performed via the input unit in the character display region as an input target character; obtaining an evaluation value for the input target character on basis of an input manner in which the touch input is performed via the input unit; determining whether the input target character is a correction target character on basis of the obtained evaluation value for the input target character; and displaying the determined correction target character on the display unit so as to be distinguishable.

According to the present invention, it is possible to make incorrect input recognized rapidly.

### BRIEF DESCRIPTION OF THE DRAWINGS

The above and other objects, advantages and features of the present invention will become more fully understood from the detailed description given hereinafter and the appended drawings which are given by way of illustration only, and thus are not intended as a definition of the limits of the present invention, and wherein:

FIG. 1 is a front view showing an outer appearance of an information terminal device according to a first embodiment;

FIG. 2 is a block diagram showing a schematic configuration of the information terminal device according to the first embodiment;

FIG. 3 is a view for explaining an example of a character input screen;

FIG. 4A is a view for explaining an example of the character input screen;

FIG. 4B is a view for explaining an example of the character input screen;

FIG. 5 is a view for explaining a detection region;

FIG. 6 is a flowchart explaining input processing;

FIG. 7 is a view showing a configuration of a data table;

FIG. 8A is a view for explaining a calculation procedure of an evaluation value;

FIG. 8B is a view for explaining the calculation procedure of the evaluation value;

FIG. 9A is a view for explaining a calculation procedure of an evaluation value;

FIG. 9B is a view for explaining the calculation procedure of the evaluation value;

FIG. 10A is a view for explaining a calculation procedure of an evaluation value;

FIG. 10B is a view for explaining the calculation procedure of the evaluation value;

FIG. 11 is a view for explaining an example of the character input screen;

FIG. 12 is a view for explaining an example of the character input screen;

FIG. 13 is a view for explaining an example of the character input screen;

FIG. 14 is a view for explaining the detection region;

FIG. 15 is a front view showing an outer appearance of an information terminal device according to a second embodiment;

FIG. 16 is a block diagram showing a schematic configuration of the information terminal device according to the second embodiment;

FIG. 17A is a view for explaining an example of a character input screen;

FIG. 17B is a view for explaining an example of the character input screen;

FIG. 18 is a flowchart explaining input processing;

FIG. 19 is a view for explaining a configuration of a data table;

FIG. 20A is a view explaining a calculation procedure of an evaluation value;

FIG. 20B is a view explaining the calculation procedure of the evaluation value;

FIG. 21A is a view explaining a calculation procedure of an evaluation value;

FIG. 21B is a view explaining the calculation procedure of the evaluation value;

FIG. 22 is a view for explaining an example of a character input screen;

FIG. 23 is a view for explaining an example of the character input screen;

FIG. 24A is a view for explaining a detection region; and

FIG. 24B is a view for explaining the detection region.

### DETAILED DESCRIPTION OF THE PREFERRED EMBODIMENT

Hereinafter, preferred embodiments according to the present invention will be described with reference to the drawings. Though the after-mentioned embodiments are provided with various technically preferred limitations to perform the present invention, the scope of the present invention is not limited to the following embodiments and illustrated examples.

### First Embodiment

First, a configuration of an information terminal device according to the first embodiment of the present invention will be described.

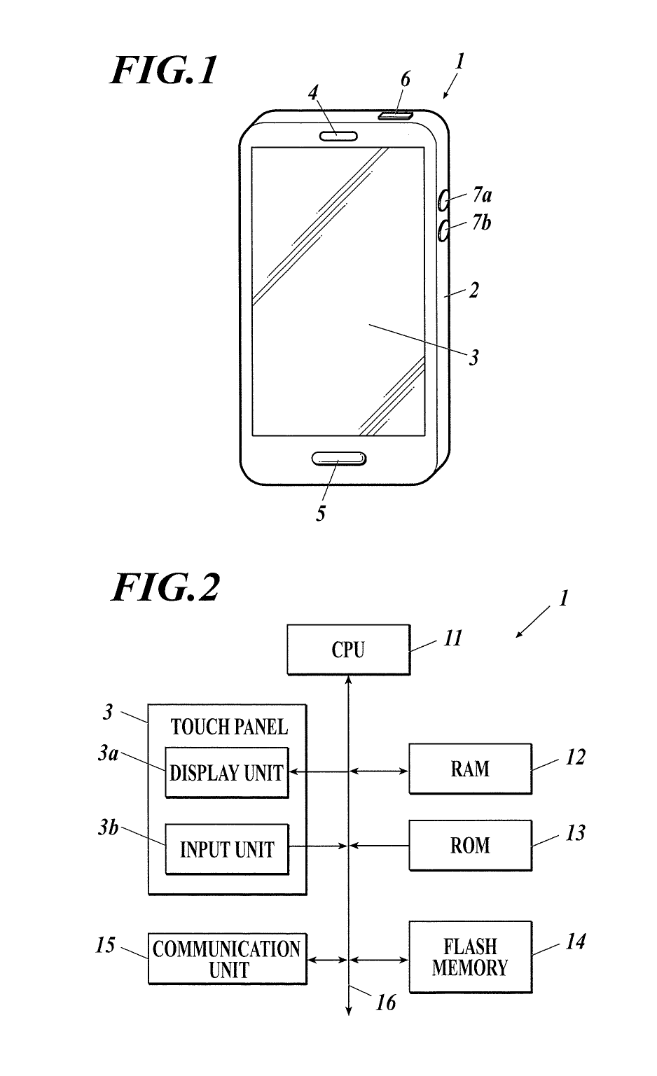

As shown in FIG. 1, the information terminal device 1 is a smartphone having a telephone function, for example. The information terminal device 1 includes a thin plate-like main body 2 and a touch panel 3 arranged on a surface of the main body 2.

The touch panel 3 has, in an integrated manner, a display unit 3a as a display unit for displaying an image and an input unit 3b as an input unit which is arranged on the entire surface of the display screen of the display unit 3a and touched by a finger, a stylus pen or such like to directly perform input (see FIG. 2).

A speaker 4 for listening is provided above the display unit 3a and a microphone 5 for speaking is provided below the display unit 3a.

A power button 6 for turning on and off the information terminal device 1 is arranged on the upper end surface of the main body 2, and volume buttons 7a and 7b for controlling the receiver volume and such like are arranged on a lateral surface.

The information terminal device 1 has a function as a character input device for inputting characters in addition to communication and telephone functions and such like.

As shown in FIG. 2, the information terminal device 1 is configured by including a CPU (Central Processing Unit) 11, a RAM (Random Access Memory) 12, a ROM (Read Only Memory) 13, a flash memory 14 and a communication unit 15 in addition to the above-mentioned touch panel 3, which are connected to each other via a bus 16.

The CPU 11 reads out a system program stored in the ROM 13, opens the system program into a work area in the RAM 12 and controls the units in accordance with the system program. The CPU 11 reads out a processing program stored in the ROM 13 to open it into the work area and executes various types of processing.

The display unit 3a in the touch panel 3 includes a LCD (Liquid Cristal Display) or such like and displays a display screen such as a character input screen in accordance with an instruction by a display signal which is input from the CPU 11. That is, the CPU 11 functions as a display control unit which controls display in the display unit 3a.

The input unit 3b receives a position input on the display screen of the display unit 3a by a finger or a stylus pen, and outputs the position (coordinates) information to the CPU 11.

The RAM 12 is a volatile memory and forms a work area for temporarily storing various programs to be executed and data according to the various programs.

The ROM 13 is a read only memory and stores the programs for executing various types of processing and data to be read out. The programs are stored in the ROM 13 in a form of computer readable program code.

The flash memory 14 is a non-volatile memory storing information so as to be readable and writable.

The communication unit 15 sends and receives data for telephone and communication with outside. The information terminal device 1 is configured to be connectable to a communication network including the Internet via the communication unit 15.

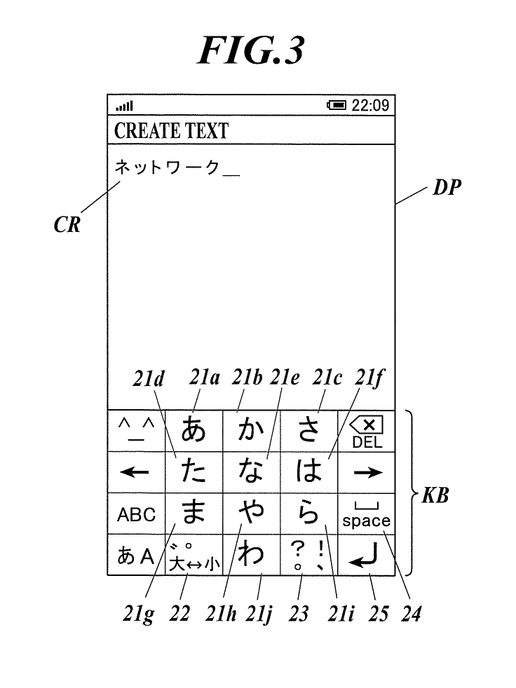

In the information terminal device 1 in the embodiment, as shown in FIG. 3, characters can be input by using a software keyboard KB displayed on a character input screen DP of the display unit 3a, for example.

Specifically, when a character is to be input, a character display region CR is formed at the upper part of the character input screen DP, the character can be input by touching and flicking (sliding) the software keyboard KB displayed at the lower part of the character input screen DP, and the input character is displayed in the character display region CR.

The software keyboard KB includes kana keys 21a to 21j for inputting kana characters (here, kana are Japanese syllables), an option key 22 for adding a dull sound/p-sound symbol to the input kana character and converting the kana character into a small letter, a mark key 23 for inputting a mark, a space key 24 and an enter key 25. ¥

The kana key 21a is a key for inputting characters [symbol] (a), [symbol] (i), [symbol] (u), [symbol] (e) and [symbol] (o).

The kana key 21b is a key for inputting characters [symbol] (ka), [symbol] (ki), [symbol] (ku), [symbol] (ke) and [symbol] (ko).

The kana key 21c is a key for inputting characters [symbol] (sa), [symbol] (si), [symbol] (su), [symbol] (se) and [symbol] (so).

The kana key 21d is a key for inputting characters [symbol] (ta), [symbol] (ti), [symbol] (tu), [symbol] (te) and [symbol] (to).

The kana key 21e is a key for inputting characters [symbol] (na), [symbol] (ni), [symbol] (nu), [symbol] (ne) and [symbol] (no).

The kana key 21f is a key for inputting characters [symbol] (ha), [symbol] (hi), [symbol] (hu), [symbol] (he) and [symbol] (ho).

The kana key 21g is a key for inputting characters [symbol] (ma), [symbol] (mi), [symbol] (mu), [symbol] (me) and [symbol] (mo).

The kana key 21h is a key for inputting characters [symbol] (ya), [symbol] (yu) and [symbol] (yo).

The kana key 21i is a key for inputting characters [symbol] (ra), [symbol] (ri), [symbol] (ru), [symbol] (re) and [symbol] (ro).

The kana key 21j is a key for inputting characters [symbol] (wa), [symbol] (wo) and [symbol] (n).

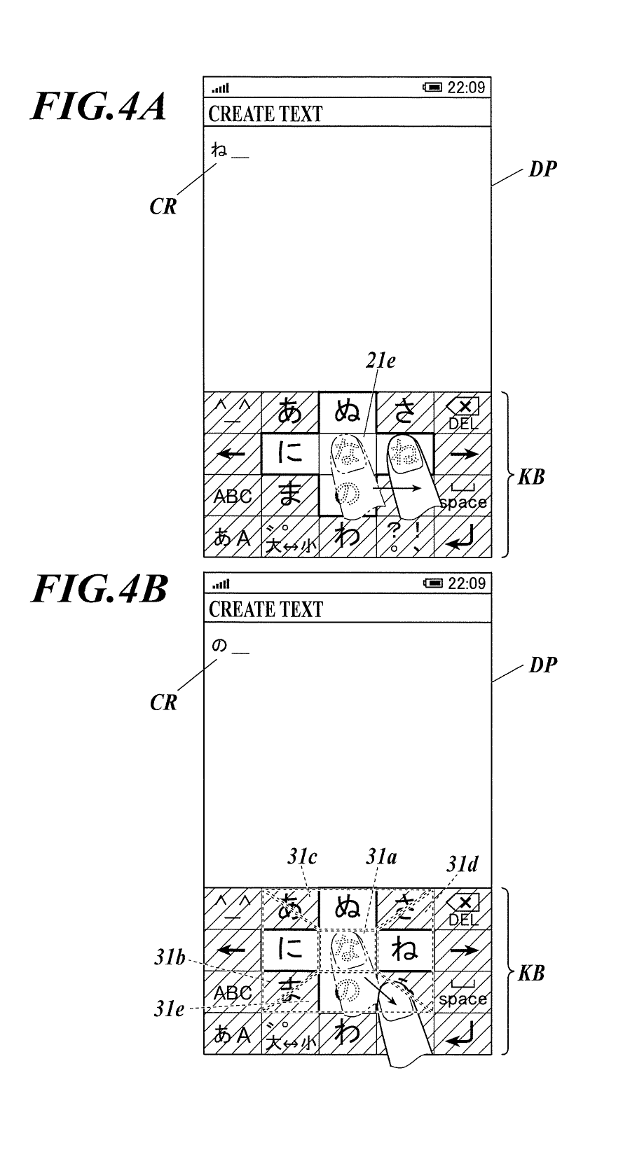

For example, when the character [symbol] (ne) is to be input by using the above-mentioned software keyboard KB, the kana key 21e is touched as shown in FIG. 4A. Then, the characters [symbol] (ni), [symbol] (nu), [symbol] (ne) and [symbol] (no) composing the [symbol] (na) column are highlighted in the respective four sides of the region displaying the character [symbol] (na), and the other keys are grayed out to indicate they are invalid.

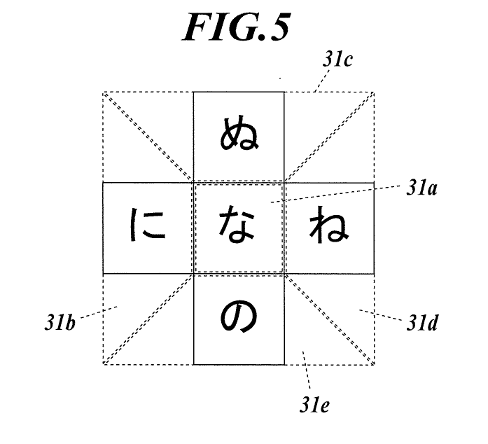

When a flick operation is performed in the right direction where [symbol] (ne) is displayed with the finger touching the touch panel 3 and the finger is lifted off the touch panel 3 at the position of [symbol] (ne), the character [symbol] (ne) is input and displayed in the character display region CR. In the embodiment, characters can be input in such way. The detection region of each character will be described with reference to FIG. 5. When the kana key 21e is touched, [symbol] (na) detection region 31a which is the touch detection range of the character [symbol] (na) is set at the region superposing the region displaying [symbol] (na).

The [symbol] (ni) detection region 31b, [symbol] (nu) detection region 31c, [symbol] (ne) detection region 31d and [symbol] (no) detection region 31e which are the respective touch detection ranges of [symbol] (ni), [symbol] (nu), [symbol] (ne) and [symbol] (no) are set to the left, upper, right and lower sides of the [symbol] (na) detection region 31a, respectively. Each of the [symbol] (ni) detection region 31b, [symbol] (nu) detection region 31c, [symbol] (ne) detection region 31d and [symbol] (no) detection region 31e is formed in a nearly trapezoidal shape with an increasing area outwardly.

Since the detection region of each of the characters is set as described above in the embodiment, for example, the character [symbol] (ne) can be input by touching the [symbol] (na) detection region 31a and thereafter flicking toward any position in the [symbol] (ne) detection region 31d.

The characters [symbol] (ni), [symbol] (nu) and [symbol] (no) can also be input by the same operation as the character [symbol] (ne). The character [symbol] (na) can be input by touching the [symbol] (na) detection region 31a and thereafter lifting the finger off the [symbol] (na) detection region 31a without the flick operation. The characters in the other columns can also be input similarly.

There are some cases in which a user flicks wrongly and inputs an unintended character. For example, as shown in FIG. 4B, when a user intends to flick the [symbol] (ne) detection region 31d to input the character [symbol] (ne), the user may accidentally flick the [symbol] (no) detection region 31e and inputs the character [symbol] (no).

In the embodiment, since the manner of user's touch operation is evaluated and the input character which is highly likely to be wrong is displayed so as to be distinguishable as described later, the user can recognize wrong input rapidly.

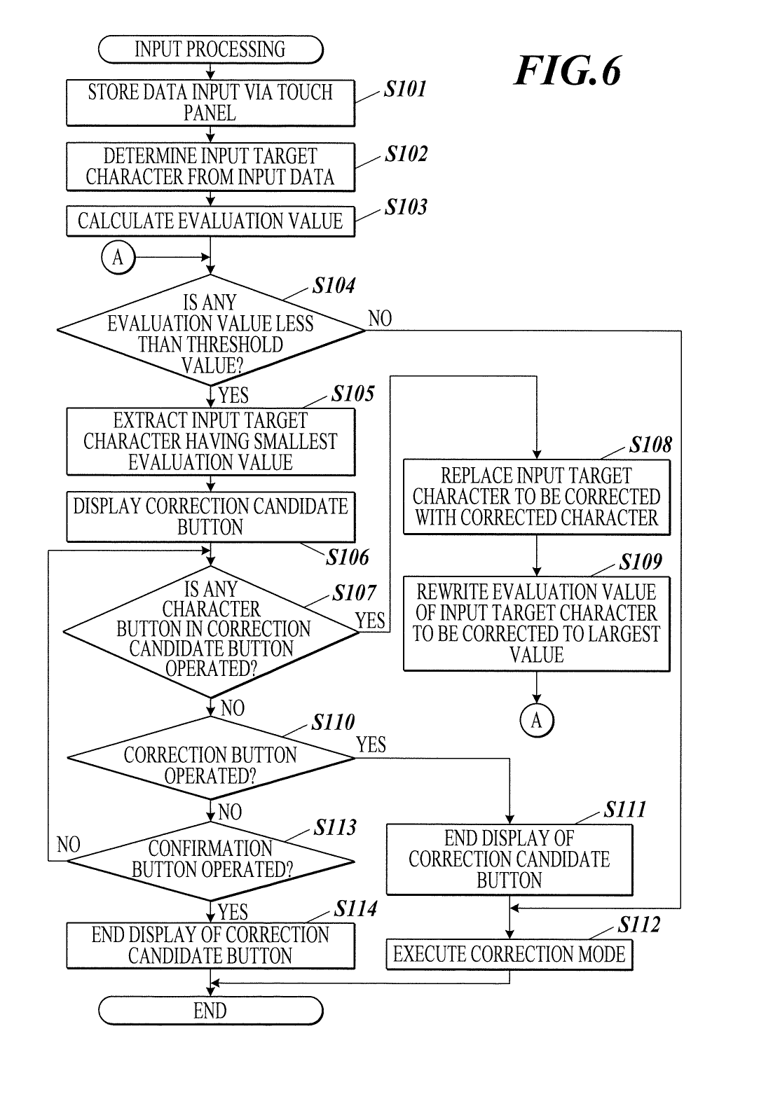

Next, input processing executed by the CPU 11 in the information terminal device 1 configured as described above will be described with reference to FIG. 6. The input processing is executed when a user inputs characters, for example.

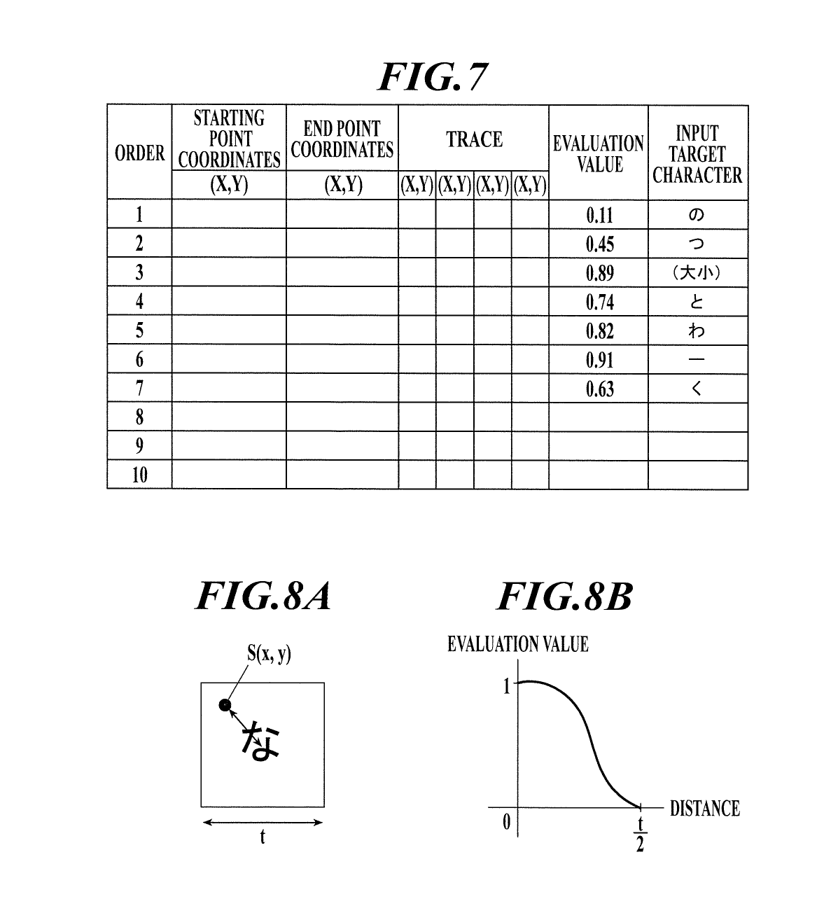

First, the CPU 11 stores input data regarding an operation via the touch panel 3 (step S101). Specifically, the CPU 11 stores data regarding input start coordinates which are the coordinates of the position where the user starts the input by touching the touch panel 3, input end coordinates which are the coordinates of the position where the user ends the input by the touch operation of the touch panel 3 and the trace of the flick operation from the input start coordinates to the input end coordinates in a predetermined region of the RAM 12 in a form of data table as shown in FIG. 7.

That is, the CPU 11 functions as a position detecting unit which detects the input starting position where the touch input is started by an input unit and the input end position where the touch input ends after a slide operation from the input starting position for each input target character.

Next, the CPU 11 determines the input target character from input data stored in the RAM 12 (step S102).

Specifically, the CPU 11 specifies the detection region on the basis of the input start coordinates and the input end coordinates in the data table stored in the RAM 12 and thereby determines the input target character.

For example, the input target character is [symbol] (ne) when the input start coordinates belong to the [symbol] (na) detection region 31a and the input end coordinates belong to the [symbol] (ne) detection region 31d in FIG. 5. The determined input target character is stored in the data table shown in FIG. 7 and displayed in the character display region CR on the character input screen DP.

Next, the CPU 11 calculates an evaluation value on the basis of the input data stored in the RAM 12 and stores the evaluation value in a predetermined field of the data table shown in FIG. 7 (step S103). The evaluation value is obtained for each input target character.

Here, the calculation procedure of the evaluation value in the embodiment will be described specifically.

First, the CPU 11 obtains the distance from the center of the detection region of character, to which the input start coordinates S(x, y) belong, to the input start coordinates S(x, y) as shown in FIG. 8A, and calculates an evaluation value on the basis of the obtained distance.

The evaluation value is calculated with reference to a conversion table such as an LUT (Look Up Table) as shown in FIG. 8B, for example.

In the conversion table, the evaluation value is ranged from 0 to 1 and is weighted so as to be large to a certain distance from the center and significantly small for the larger distance.

The distance is ranged from 0 to the half of side length (t) of the detection region. The conversion table is not limited to that shown in FIG. 8B, and various conversion tables can be adopted. For example, the evaluation value may be decreased linearly with the distance.

Thus, the CPU 11 functions as a distance calculation unit which calculates the distance to the touched position from the central position in the touch detection range of the input target character corresponding to the position where the touch input is performed via the input unit.

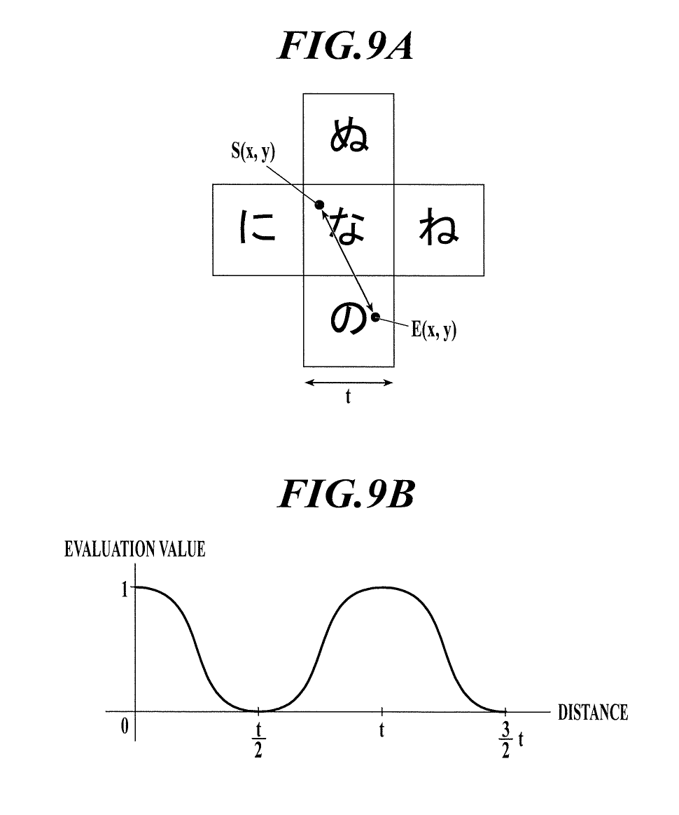

Second, the CPU 11 obtains the distance from the input start coordinates S(x, y) to the input end coordinates E(x, y) as shown in FIG. 9A and calculates an evaluation value on the basis of the obtained distance.

The evaluation value is calculated with reference to the conversion table as shown in FIG. 9B, for example. In the conversion table, the evaluation value is ranged from 0 to 1 and varies with the distance from the input start coordinates S(x, y) to the input end coordinates E(x, y).

According to the conversion table, when the input character is [symbol] (na), for example, the evaluation value is larger with a smaller distance since the smaller distance from the input start coordinates S(x, y) to the input end coordinates E(x, y) is more preferable. When the input target character is [symbol] (ni), [symbol] (nu), [symbol] (ne) and [symbol] (no), the evaluation value is larger as approaching the side length (t) of the detection region corresponding to the character [symbol] (na) since it is more preferable that the distance from the input start coordinates S(x, y) to the input end coordinates E(x, y) is closer to the side length (t).

The conversion table is not limited to that of FIG. 9B and various types can be adopted. For example, the evaluation value may linearly increase and decrease with the distance from the input start coordinates S(x, y) to the input end coordinates E(x, y).

Thus, the CPU 11 functions as a position detecting unit which detects the input starting position where the touch input via the input unit is started and the input end position where the touch input ends after a slide operation from the input starting position for each input target character.

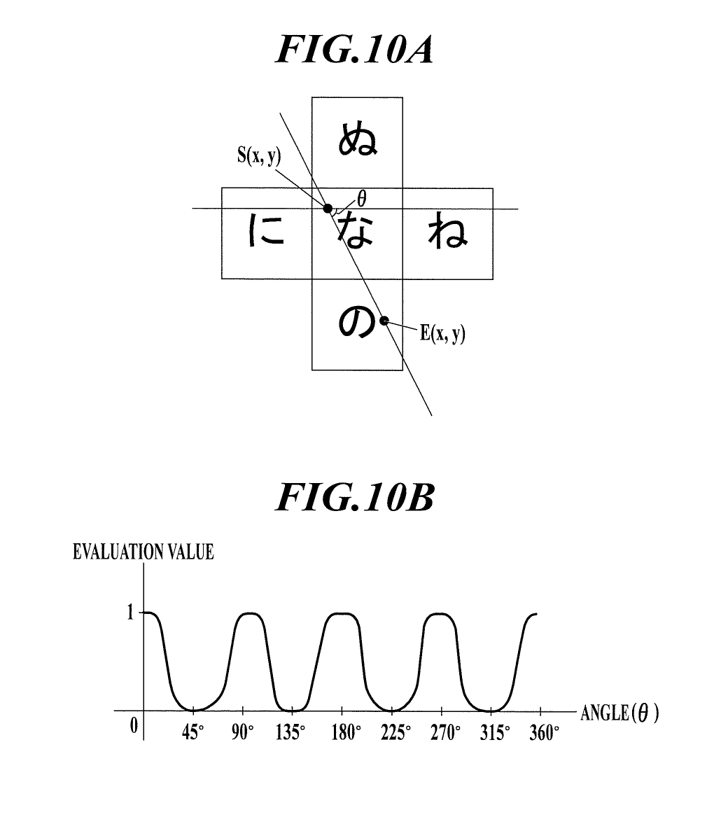

Third, the CPU 11 obtains an angle 8 between the straight line passing through the input start coordinates S(x, y) and the input end coordinates E(x, y) and the horizontal line as shown in FIG. 10A and calculates an evaluation value on the basis of the obtained angle θ.

The evaluation value is calculated with reference to a conversion table as shown in FIG. 10B, for example. In the conversion table, the evaluation value is ranged from 0 to 1 and converted according to the angle θ.

That is, the evaluation value is larger as the straight line passing through the input start coordinates S(x, y) and the input end coordinates E(x, y) is closer to the horizontal or vertical line, and the evaluation value is smaller as the straight line is inclined more.

The conversion table is not limited to that of FIG. 10B, and various conversion tables can be adopted. For example, the evaluation value may be linearly decreased and increased in accordance with the angle θ.

In such way, the CPU 11 functions as an angle detecting unit which detects the angle of straight line connecting the input starting position and the input end position detected by the detecting unit.

After the three evaluation values are calculated as mentioned above, the average value of the evaluation values is obtained and the obtained average evaluation value is stored in the data table.

The evaluation value to be stored in the data table may be obtained from one or two of the above three evaluation values.

The method for obtaining the evaluation value is not limited to the above mentioned methods, and various methods can be adopted as long as it can evaluate the input manner in which the touch input is performed.

In such way, the CPU 11 functions as an evaluation unit which obtains the evaluation value for each of the input target characters on the basis of the input manner of touch input via the input unit.

Returning to FIG. 6, the CPU 11 determines whether any evaluation value of the input target characters is less than a threshold value with reference to the data table shown in FIG. 7 (step S104). Though the threshold value is set to “0.5” in the embodiment, for example, the threshold value may be set to any appropriate value.

If it is determined that there is an input target character having an evaluation value less than the threshold value (step S104: YES), the CPU 11 extracts the input target character which has the smallest evaluation value as a correction target character (step S105). Since the input target character having the smallest evaluation value is most likely to be incorrect, this input target character is extracted in the embodiment.

In such way, the CPU 11 functions as a correction determination unit which determines the correction target character from among the input target characters on the basis of the evaluation values for the input target characters obtained by the evaluation unit.

Then, the CPU 11 displays a correction candidate button on the character input screen (step S106). Specifically, when the input target character having the smallest evaluation value is [symbol] (no) as shown in FIG. 7, for example, the CPU 11 highlights the character [symbol] (no) in the character string of “ [symbol] ” displayed in the character display region CR so as to be recognized as the character to be corrected as shown in FIG. 11. A correction candidate button TS corresponding to the character [symbol] (no) is displayed near the character string of “ [symbol] [symbol] ”. The correction candidate button TS includes characters that are [symbol] (na), [symbol] (ni), [symbol] (nu), [symbol] (ne) and Ψ(no) as replacement character candidates corresponding to the character Ψ(no).

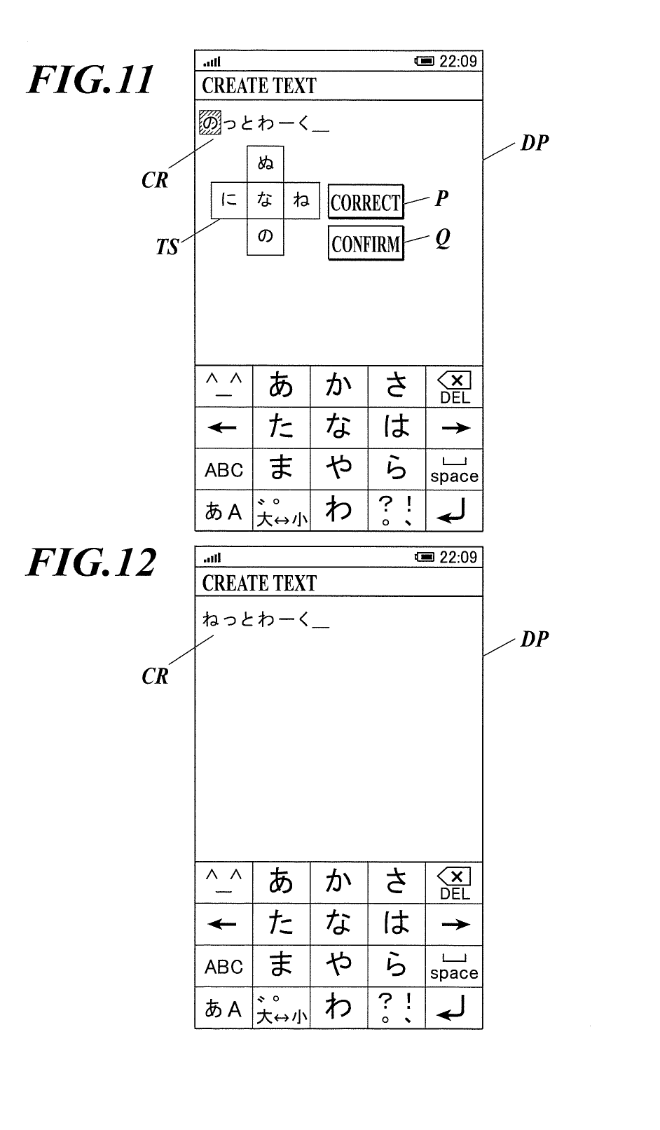

The CPU 11 determines whether any of the character buttons forming the correction candidate button TS is touched (step S107). If it is determined that any of the character buttons forming the correction candidate button TS is touched (step S107: YES), the CPU 11 replaces the input target character to be corrected with the character corresponding to the touched character button (step S108). For example, when the character button [symbol] (ne) in the correction candidate button TS is touched in FIG. 11, the input target character [symbol] (no) is corrected to [symbol] (ne) as shown in FIG. 12. The input target character stored in the data table is also corrected from [symbol] (no) to [symbol] (ne).

In such way, the CPU 11 functions as a correction input receiving unit which receives a correction input of an input target character made by the touch input via the input unit to correct the input target character determined as the correction target character.

The CPU 11 rewrites the evaluation value of the input target character to be corrected to the largest value (step S109), and thereafter executes the processing of step S104. Specifically, the CPU 11 rewrites the evaluation value stored in the data table and corresponding to the corrected input target character to “1” that is the largest value.

On the other hand, if it is not determined that any of the character buttons forming the correction candidate button TS is touched (step S107: NO), the CPU 11 determines whether the correction button P is touched (step S110).

Specifically, as shown in FIG. 11, the CPU 11 can perform the determination according to whether a touch operation is performed with respect to the correction button P which is displayed on the right of the correction candidate button TS displayed in the character display region CR on the character input screen DP.

If it is determined that the correction button P is touched (step S110: YES), the CPU 11 ends display of the correction candidate button TS (step S111), thereafter executes a correction mode for correcting a character other than the correction target character (step S112), and ends the processing.

In the correction mode, for example, the character can be corrected by moving the cursor key forward or backward and operating the “DEL” key or the like in the software keyboard KB in FIG. 3.

On the other hand, if it is not determined that the correction button P is touched in step S110 (step S110: NO), the CPU 11 determines whether the confirmation button Q is touched (step S113).

Specifically, as shown in FIG. 11, the determination can be made according to whether a touch operation is performed with respect to the confirmation button Q which is displayed on the right of the correction candidate button TS displayed in the character display region CR on the character input screen DP.

If it is determined that the confirmation button Q is touched (step S113: YES), the CPU 11 ends display of the correction candidate button TS, confirms the input (step S114), and thereafter ends the processing.

On the other hand, if it is not determined that the confirmation button Q is touched (step S113: NO), the CPU 11 executes the processing in step S107.

In step S104, if it is not determined that there is an input target character having an evaluation value less than the threshold value (step S104: NO), the CPU 11 executes the processing of step S112.

When characters are input continuously, the input processing is activated again.

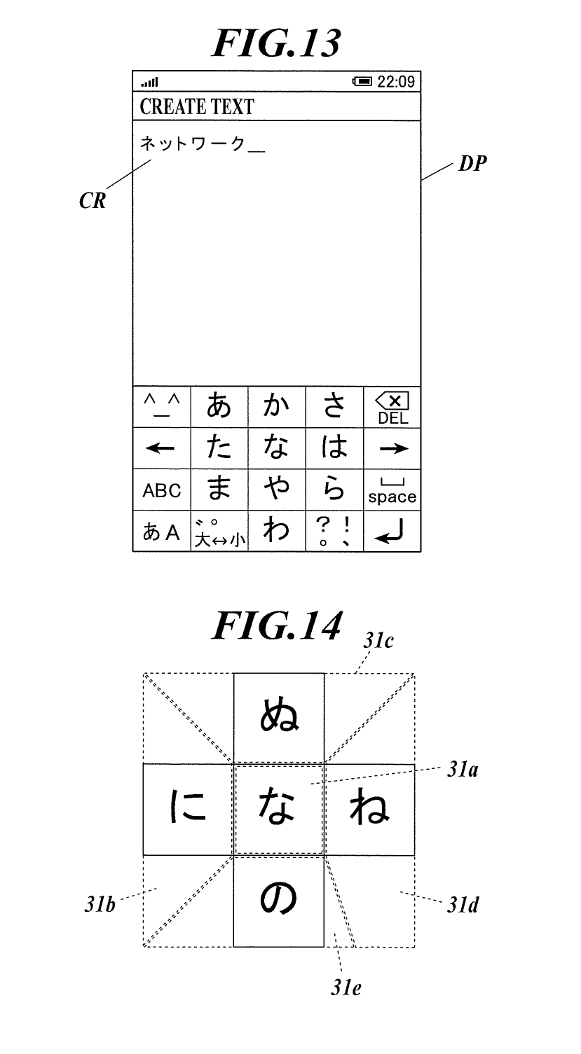

After executing the above mentioned input processing, the CPU 11 converts the character string [symbol] displayed in the character display region CR on the character input screen DP to [symbol] [symbol] as shown in FIG. 13 by a predetermined conversion operation.

Though the input target character having the smallest evaluation value is extracted as the correction target character in the embodiment, the number of correction target character to be extracted is not limited to one and can be appropriately set. All the input target characters having the evaluation values less than the threshold value may be extracted as the correction target character.

In the embodiment, when correction is performed, the CPU 1 may function as a detection range enlargement unit which controls so as to change the ranges of detection regions corresponding to the characters before and after the correction.

Specifically, when the input target character is corrected, in a case where the input target character before correction is [symbol] (no) and the input target character after the correction is [symbol] (ne), the CPU 11 changes the ranges of detection regions so as to enlarge the range of [symbol] (ne) detection region 31d and reduce the range of [symbol] (no) detection region 31e as shown in FIG. 14.

Thus, incorrect input by a user can be more prevented.

In such way, the CPU 11 functions as the detection range enlargement unit which enlarges the touch detection range of the input target character for which the correction input is received by the correction input receiving unit.

The ranges of detection regions may be changed when a character is corrected once or when a character is corrected a plurality of times. The change amount of the ranges of detection regions may be variable according to the number of times the correction is performed.

The change amount of the ranges of detection regions may be variable according to the input start coordinates, input end coordinates and the trace. The change amount of the ranges of detection regions may also be variable according to the evaluation value.

### Second Embodiment

Next, the configuration of an information terminal device according the second embodiment of the present invention will be described.

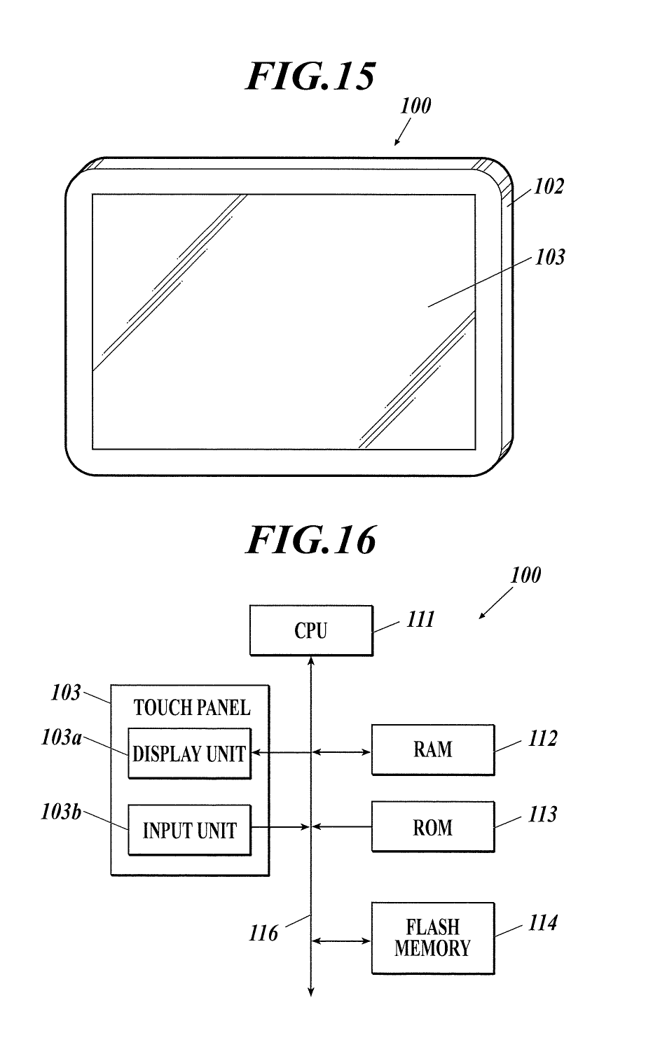

As shown in FIG. 15, the information terminal device 100 is a tablet terminal, for example. The information terminal device 100 includes a thin plate-like main body 102 and a touch panel 103 provided on a surface of the main body 102. The touch panel 103 integrally includes a display unit 103a as a display unit for displaying an image and an input unit 103b as an input unit which is provided on the entire surface of the display screen of the display unit 103a and touched by a finger, a stylus pen or the like to directly perform input (see FIG. 16).

The information terminal device 100 has a function as a character input device for inputting characters in addition to the communication function and the like.

As shown in FIG. 16, the information terminal device 100 is configured by including the CPU 111, RAM 112, ROM 113 and flash memory 114 in addition to the above mentioned touch panel 103, and the units are connected to each other via a bus 116. Since the functions of the touch panel 103, CPU 111, RAM 112, ROM 113 and flash memory 114 are similar to those of the information terminal device 1 in the first embodiment, the detailed description thereof is omitted.

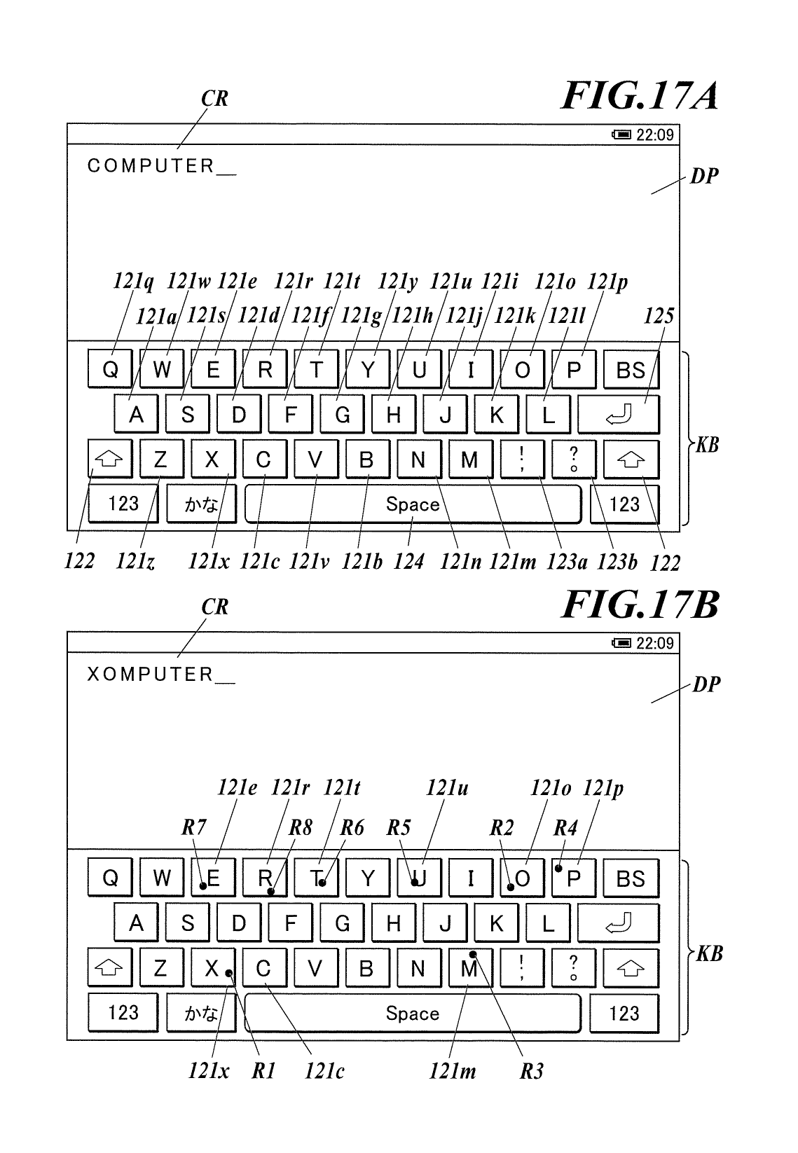

In the information terminal device 100 in the embodiment, characters can be input by using a software keyboard KB displayed on the character input screen DP of the display unit 103a as shown in FIG. 17A, for example.

Specifically, when a character is to be input, the character display region CR is formed in the upper part of the character input screen DP, the character can be input by touching the software keyboard KB displayed in the lower part of the character input screen DP, and the input character is displayed in the character display region CR.

The software keyboard KB is a software keyboard having QWERTY arrangement with Roman character keys 121a to 121z for inputting Roman characters, shift keys 122 and 122, mark keys 123a and 123b for inputting marks, a space key 124 and an enter key 125. In the embodiment, the detection region for each character is set so as to superpose the character key.

Thus, as shown in FIG. 17A, by touching the C key 121c, O key 121o, M key 121m, P key 121p, U key 121u, T key 121t, E key 121e and R key 121r in the software keyboard KB in this order, for example, the touch operation of the detection region of each of the characters is detected, each of the characters C, O, M, P, U, T, E and R is input, and the character string “COMPUTER” is displayed in the character display region CR.

Characters can be input in such way in the embodiment.

There is a case where a user performs a wrong touch operation and inputs a character different from the intended character. For example, as shown in FIG. 17B, when the user performs touch operations with respect to the touch positions R1 to R8 in order so as to input “COMPUTER”, “XOMPUTER” is input since the touch position R1 is the X key 121x which is not the C key 121c.

That is, though the user intends to touch the C key 121c, the X key 121X is touched, which is an incorrect input. This is due to the difficulties in finding the correct key position by tactile sense since the keyboard has no irregularities as in an actual keyboard.

In the embodiment, since the manner of user's touch operation is evaluated and the character input which is highly likely to be incorrect is displayed so as to be distinguishable as described later, the user can recognize the incorrect input rapidly.

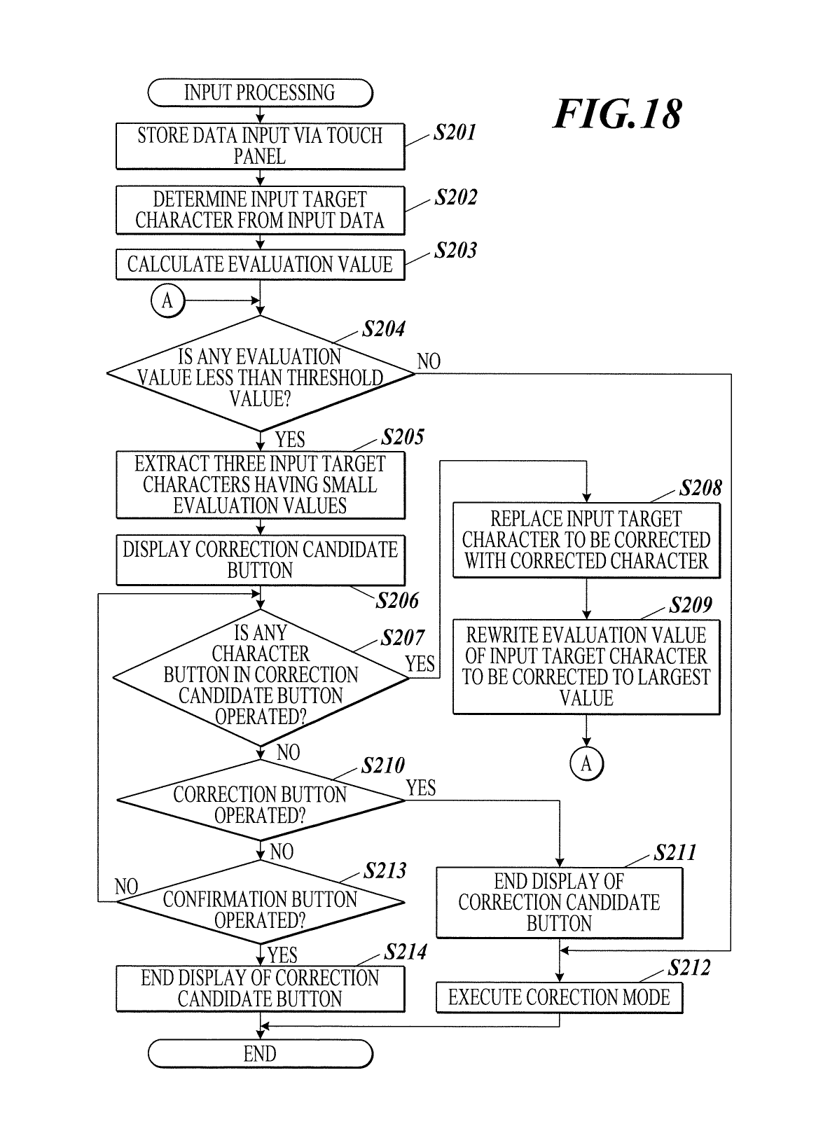

Next, input processing executed by the CPU 111 in the information terminal device 100 configured as described above will be described with reference to FIG. 18.

The input processing is executed when a user inputs characters, for example.

First, the CPU 111 stores input data regarding the operation with respect to the touch panel 103 (step S201).

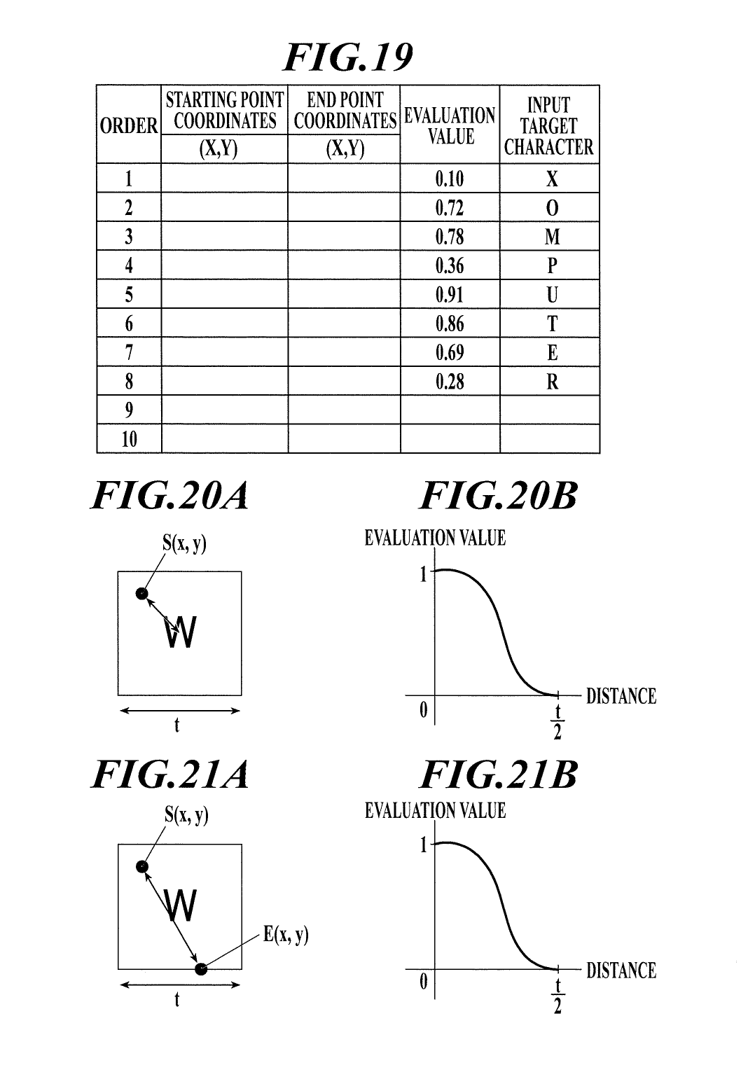

Specifically, each set of data regarding input start coordinates and input end coordinates is stored in a predetermined region of the RAM 12 in a form of data table as shown in FIG. 19. The input start coordinates and the input end coordinates are obtained in the same method as the above-mentioned first embodiment.

Next, the CPU 111 determines an input target character from the input data stored in the RAM 112 (step S202).

Specifically, the CPU 111 specifies a character detection region to which the input end coordinates in the data table stored in the RAM 112 belongs, and thereby determines the input target character. The determined input target character is stored in the data table shown in FIG. 19 and the character is displayed in the character display region CR on the character input screen DP.

Next, the CPU 111 calculates the evaluation value on the basis of the input data stored in the RAM 112, and stores the evaluation value in a predetermined field of the data table shown in FIG. 19 (step S203). The evaluation value is obtained for each input target character.

Here, the calculation procedure of the evaluation value in the embodiment will be described in detail.

First, as shown in FIG. 20A, the CPU 111 calculates the distance from the center of the character detection region, to which the input start coordinates S(x, y) belong, to the input start coordinates S(x, y), and calculates an evaluation value on the basis of the obtained distance. The evaluation value is calculated with reference to the conversion table shown in FIG. 20B, for example. In the conversion table, the evaluation value is ranged from 0 to 1 and varies according to the distance from the center of the detection region to the input start coordinates S(x, y).

The distance is ranged from 0 to the half of one side length (t) of the detection region. The conversion table is not limited to that of FIG. 20B and various conversion tables can be adopted. For example, the evaluation value may be linearly decreased according to the distance.

Second, the CPU 111 obtains the distance from the input start coordinates S(x, y) to the input end coordinates E(x, y) as shown in FIG. 21A, and calculates an evaluation value on the basis of the obtained distance.

That is, the CPU 111 obtains the evaluation value from the distance of slide operation from the input start coordinates S(x, y) to the input end coordinates E(x, y). The evaluation is calculated with reference to the conversion table shown in FIG. 21B, for example. In the conversion table, the evaluation value is ranged from 0 to 1 and varies according to the distance from the input start coordinates S(x, y) to the input end coordinates E(x, y).

According to the conversion table, smaller distance from the input start coordinates S(x, y) to the input end coordinates E(x, y), that is, a smaller movement amount of a finger or the like for touch operation is more preferable, and thus, the evaluation value is larger as the distance is smaller.

The conversion table is not limited to that of FIG. 21B, and various types can be adopted. For example, the evaluation value may be linearly decreased according to the distance from the input start coordinates S(x, y) to the input end coordinates E(x, y).

The CPU 111 functions as a length detecting unit for detecting the length of slide operation from the input starting position to the input end position detected by the position detecting unit.

After the two evaluation values are calculated as mentioned above, the average value of the evaluation values is calculated and the calculated average evaluation value is stored in the data table.

The evaluation value to be stored in the data table may be calculated from one of the above two evaluation values.

The method for obtaining the evaluation value is not limited to the above mentioned method and various methods can be adopted as long as the input manner of touch input can be evaluated.

Returning to FIG. 18, the CPU 111 next determines whether there is an input target character having an evaluation value less than a threshold value with reference to the data table in FIG. 19 (step S204). Though the threshold value is set to “0.5” in the embodiment, for example, the threshold value can be set to any appropriate value.

If it is determined that there is an input target character having the evaluation value less than the threshold value (step S204: YES), the CPU 111 extracts three input target characters having the smallest evaluation values (step S205).

For example, as shown in FIG. 19, the three input target characters having the smallest evaluation values are X, P and R, and the characters are extracted as correction target characters. These input target characters are extracted in the embodiment since they are highly likely to be incorrect.

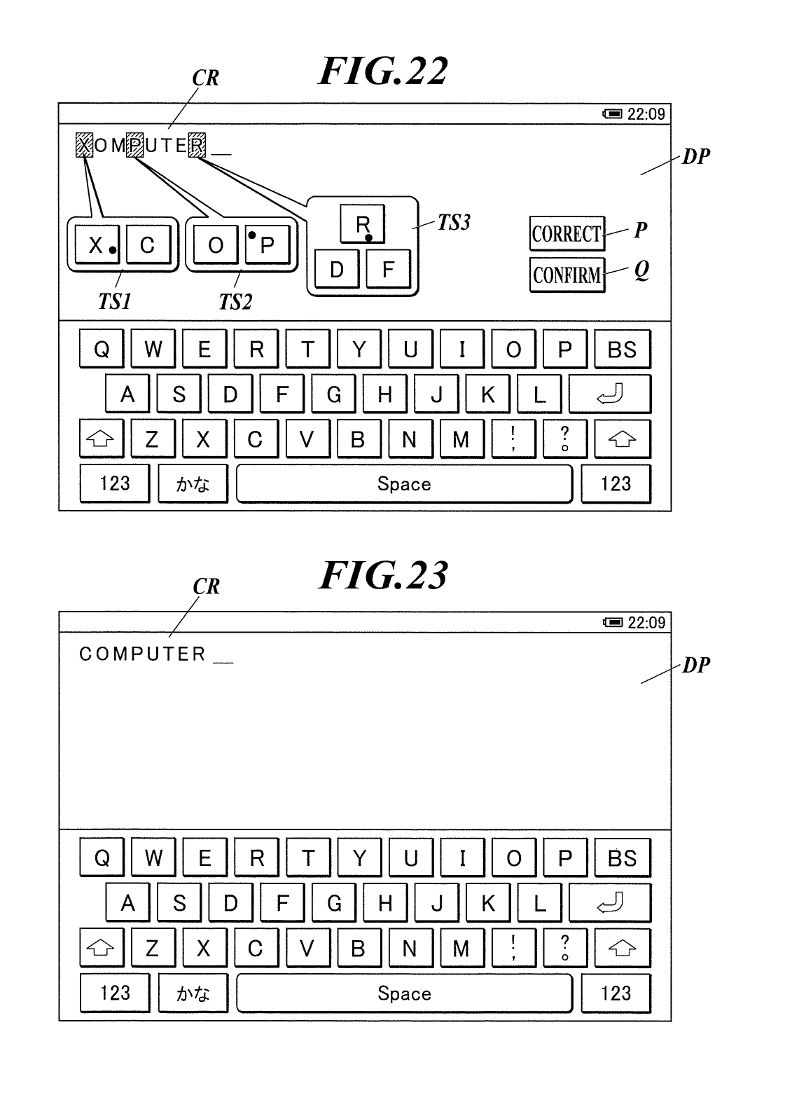

The CPU 111 displays a correction candidate button on the character input screen (step S206). Specifically, as shown in FIG. 22, the CPU 111 highlights the three input target characters X, P and R having smallest evaluation values in the character string of “XOMPUTER” displayed in the character display region CR so as to be recognized as characters to be corrected, for example.

The CPU 111 displays correction candidate buttons TS1, TS2 and TS3 respectively corresponding to the characters X, P and R near the character string “XOMPUTER”. The correction candidate button TS1 consists of character buttons X and C as replacement character candidates corresponding to the character X.

The correction candidate button TS2 consists of character buttons O and P as replacement character candidates corresponding to the character P. The correction candidate button TS3 consists of character buttons D, F and R as replacement character candidates corresponding to the character R. In the correction candidate buttons TS1 to TS3, the touched positions are respectively displayed so as to be recognized. Thus, the user can recognize the touched positions. The touched positions may not be displayed.

Next, the CPU 111 determines whether any of the character buttons consisting the correction candidate buttons TS1 to TS3 is touched (step S207).

If it is determined that any of the character buttons consisting the correction candidate buttons TS1 to TS3 is touched (step S207: YES), the CPU 111 replaces the input target character corresponding to the touched character button with the character corresponding to the touched character button (step S208).

For example, in FIG. 22, when the character button C in the correction candidate button TS1 is touched, the input target character X is corrected to C as shown in FIG. 23. The input target character stored in the data table is also corrected from X to C.

The CPU 111 rewrites the evaluation value of the input target character which is the correction target to the largest value (step S209), and thereafter executes the processing of step S204.

On the other hand, if it is not determined that any of the character buttons consisting the correction candidate buttons TS1 to TS3 is touched (step S207: NO), the CPU 111 determines whether the correction button P is touched (step S210).

Specifically, as shown in FIG. 22, the determination can be made according to whether a touch operation is performed with respect to the correction button P displayed on the right of the correction candidate button TS3 displayed in the character display region CR on the character input screen DP.

If it is determined that the correction button P is touched (step S210: YES), the CPU 111 ends display of the correction candidate buttons TS1 to TS3 (step S211), thereafter executes the correction mode for correcting a character other than the character which is the correction target (step S212), and ends the processing. In the correction mode, correction can be performed by moving forward or backward the cursor key and operating keys such as the BS key in the software keyboard KB in FIG. 17A, for example.

On the other hand, if it is not determined that the correction button P is touched (step S210: NO), the CPU 111 determines whether the confirmation button Q is touched (step S213). Specifically, as shown in FIG. 22, the determination can be made according to whether a touch operation is performed with respect to the confirmation button Q displayed on the right of the correction candidate button TS3 displayed in the character display region CR on the character input screen DP.

If it is determined that the confirmation button Q is touched (step S213: YES), the CPU 111 ends the display of correction candidate buttons TS1 to TS3 to confirm the input (step S214), and ends the processing.

On the other hand, if it is not determined that the confirmation button Q is touched (step S213: NO), the CPU 111 executes the processing of step S207.

In step S204, if it is not determined that there is an input target character having an evaluation value less than the threshold value (step S204: NO), the CPU 111 executes the processing in step S212.

When characters are input continuously, the input processing is activated again.

Though the three input target characters having the smallest evaluation values are extracted as the correction target characters in the embodiment, the number of characters to be extracted as the correction target characters can be appropriately set. All the input target characters having the evaluation values less than the threshold value may be extracted as the correction target characters.

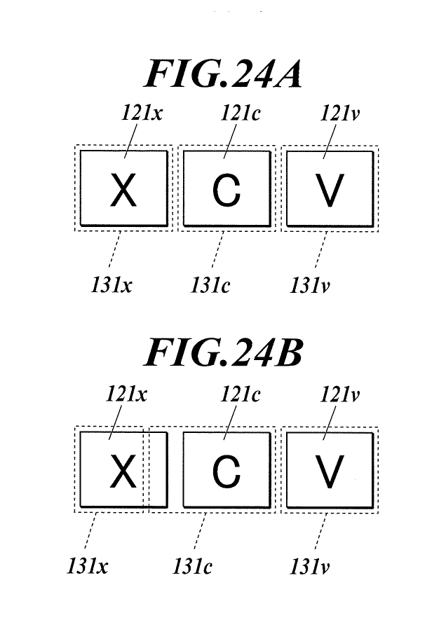

In the embodiment, when correction was performed, control may be performed so as to change the ranges of detection regions corresponding to the characters before and after the correction. Specifically, when the input target character was corrected, in a case where the input target character before correction is X and the input target character after the correction is C, the CPU 111 changes the ranges of the X detection region 131x corresponding to X key 121x and C detection region 131c corresponding to C key 121C set shown in FIG. 24A to the ranges shown in FIG. 24B so as to reduce the range of X detection region 131x and enlarge the range of C detection region 131c.

Thus, incorrect input by a user can be prevented more.

The ranges of detection regions may be changed either when the correction is performed once or when the correction is performed a plurality of times.

The change amount of the ranges of detection regions may be variable according to the number of times of correction.

The change amount of the ranges of detection regions may be variable according to the evaluation value.

The change amount of the ranges of detection regions may be variable according to the touched position.

As described above, according to the embodiment, the touch panel 3 (103) integrally includes the display unit 3a (103a) for displaying a screen and the input unit 3b (103b) which receives the touch input of a position on the screen displayed on the display unit 3a (103a).

The CPU 11 (111) displays the character input screen DP having the character display region CR on the display unit 3a (103a), associates the software keyboard KB including a plurality of characters with the touch panel 3 (103), and displays the character in the software keyboard KB corresponding to the position for which the touch input is performed via the input unit 3b in the character display region CR as the input target character.

The CPU 11 (111) obtains an evaluation value for each of the input target characters on the basis of the input manner of the touch input via the input unit 3b (103b). The CPU 11 (111) determines the correction target character from among the input target characters on the basis of the evaluation value obtained for each of the input target characters. The CPU 11 (111) displays the determined correction target character on the display unit 3a (103a) so as to be distinguishable. As a result, the user can recognize the incorrect input rapidly.

According to the embodiment, the CPU 11 (111) calculates the distance from the central position of the touch detection region of the input target character corresponding to the position where the touch input is performed via the input unit 3b (103b) to the touched position. The CPU 11 (111) obtains the evaluation value for each of the input target characters on the basis of the calculated distance. As a result, incorrect input can be appropriately detected.

According to the embodiment, the CPU 11 (111) detects the input starting position where the touch input via the input unit 3b (103b) starts and the input end position where the touch input ends after the slide operation from the input starting position for each of the input target characters. The CPU 11 (111) obtains the evaluation value for each of the input target characters on the basis of the detection result. As a result, incorrect input can be appropriately detected.

According to the embodiment, the CPU 11 (111) detects the length of slide operation from the input starting position to the input end position which were detected. The CPU 11 (111) obtains the evaluation value for each of the input target characters on the basis of the detected length. As a result, incorrect input can be appropriately detected.

According to the embodiment, the CPU 11 detects the angle of the straight line connecting the input starting position to the input end position. The CPU 11 obtains the evaluation value for each of the characters on the basis of the detected angle. As a result, incorrect input can be appropriately detected.

According to the embodiment, the CPU 11 (111) determines at least the input target character having the smallest evaluation value as the correction target character. As a result, the user can recognize the input target character which is highly likely to be incorrect more precisely.

According to the embodiment, the CPU 11 (111) receives correction input of an input target character by the touch input via the input unit 3b (103b) to correct the input target character which was determined to be the correction target character. The CPU 11 (111) replaces the input target character which was determined to be the correction target character and is displayed on the display unit 3a (103a) with the input target character for which correction input is received.

As a result, incorrect input can be appropriately corrected.

According to the embodiment, the CPU 11 (111) displays replacement character candidates corresponding to the input target character determined to be the correction target character near the correction target character displayed in the character display region CR. When a position corresponding to the display of a replacement character candidate is touched, the CPU 11 (111) receives the character of the replacement character candidate as the input target character to replace the correction target character. As a result, correction can be performed more efficiently with an easy operation.

According to the embodiment, the CPU 11 (111) enlarges the touch detection range of the input target character for which correction input was received. As a result, incorrect input thereafter can be suppressed.

According to the embodiment, when correction input is received for a character a predetermined number of times, the CPU 11 (111) enlarges the touch detection range of the input target character for which correction input was received. As a result, the touch detection range can be enlarged appropriately according to the manner of user's touch operation.

The description in the above embodiments are preferred examples of the information terminal device according to the present invention, and the present invention is not limited to the examples. In the embodiment, the input target character having the smallest evaluation value is extracted as the correction target character and displayed when there is an evaluation value less than the threshold value. However, the input target character having the smallest evaluation value may be extracted as the correction target character and displayed regardless of whether the evaluation value is less than the threshold value.

In the embodiment, the correction candidate button is displayed on the character input screen to perform correction input of a character. However, the correction input may be performed via the software keyboard KB without displaying the correction candidate button.

As the computer readable medium storing programs for executing the above processing, a non-volatile memory such as a flash memory and a portable recording medium such as a CD-ROM can also be applied in addition to the ROM, hard disk and such like.

A carrier wave also applies as the medium providing the program data via a predetermined communication line.

Various changes can also be appropriately made within the scope of the present invention with respect to the other detailed configuration and detailed operation of the components forming the information terminal device.

Though several embodiments and variations of the present invention have been described above, the scope of the present invention is not limited to the above embodiments and variations, and includes the scope of inventions, which is described in the scope of claims, and the scope equivalent thereof.

What is claimed is:

1. A character input device, comprising:
a touch panel which integrally includes a display unit for displaying a screen and an input unit for receiving a touch input at a position in the screen displayed on the display unit;
a first control unit which displays a character input screen having a character display region on the display unit, associates a keyboard including a plurality of characters with the touch panel and displays a character in the keyboard corresponding to the position where the touch input is performed via the input unit in the character display region as an input target character;
an evaluation unit which obtains an evaluation value for the input target character on basis of an input manner in which the touch input is performed via the input unit;
a determination unit which determines whether the input target character is a correction target character on basis of the evaluation value for the input target character obtained by the evaluation unit; and
a second control unit which displays the correction target character determined by the determination unit on the display unit so as to be distinguishable.

2. The character input device according to claim 1, further comprising a distance calculation unit which calculates, as the input manner, a distance from a central position of a touch detection range of the input target character corresponding to the position of the touch input performed via the input unit to the position of the touch input, wherein
the evaluation unit obtains the evaluation value for the input target character on basis of the distance calculated by the distance calculation unit.

3. The character input device according to claim 1, further comprising a position detecting unit which detects an input starting position and an input end position as the input manner for the input target character, the input starting position being a position where the touch input via the input unit starts and the input end position being a position where the touch input ends after a slide operation from the input starting position, wherein
the evaluation unit obtains the evaluation value for the input target character on basis of a detection result by the position detecting unit.

4. The character input device according to claim 3, further comprising a length detecting unit which detects, as the input manner, a length of the slide operation from the input starting position to the input end position detected by the position detecting unit, wherein
the evaluation unit obtains the evaluation value for the input target character on basis of the length detected by the length detecting unit.

5. The character input device according to claim 3, further comprising an angle detecting unit which detects, as the input manner, an angle between a straight line and a horizontal line, the straight line connecting the input starting position and the input end position detected by the position detecting unit, wherein
the evaluation unit obtains the evaluation value for the input target character on basis of the angle detected by the angle detecting unit.

6. The character input device according to claim 1, wherein the determination unit determines at least an input target character having a smallest evaluation value as the correction target character.

7. The character input device according to claim 1, further comprising a receiving unit which receives a correction input of an input target character by a touch input via the input unit with respect to the input target character that is determined to be the correction target character, wherein
the second control unit replaces the input target character that is displayed on the display unit and determined to be the correction target character with the input target character for which the receiving unit receives the correction input.

8. The character input device according to claim 7, wherein
the second control unit displays a replacement character candidate corresponding to the input target character determined to be the correction target character by the determination unit near the correction target character displayed in the character display region, and
when the touch input is performed at a position corresponding to display of the replacement character candidate, the receiving unit receives the replacement character candidate as the input target character to replace the correction target character.

9. The character input device according to claim 7, further comprising an enlargement unit which enlarges a touch detection range of the input target character for which the correction input is received by the receiving unit.

10. The character input device according to claim 9, wherein the enlargement unit enlarges the touch detection range of the input target character for which the correction input is received when the correction input is performed for the input target character a predetermined number of times.

11. A non-transitory computer readable medium that stores a program for making a computer execute a procedure, the computer being a character input device with a touch panel which integrally includes a display unit for displaying a screen and an input unit for receiving a touch input at a position in the screen displayed on the display unit, the procedure comprising:
controlling so as to display a character input screen having a character display region on the display unit, associate a keyboard including a plurality of characters with the touch panel and display a character in the keyboard corresponding to the position where the touch input is performed via the input unit in the character display region as an input target character;
obtaining an evaluation value for the input target character on basis of an input manner in which the touch input is performed via the input unit;
determining whether the input target character is a correction target character on basis of the obtained evaluation value for the input target character; and
displaying the determined correction target character on the display unit so as to be distinguishable.
